(19) United States
(12) Patent Application Publication
(10) Pub. No.: US 2013/0230235 A1
(43) Pub. Date: Sep. 5, 2013

(54) INFORMATION PROCESSING APPARATUS AND INFORMATION PROCESSING METHOD

(71) Applicants: Keisuke Tateno, Kawasaki-shi (JP); Daisuke Kotake, Yokohama-shi (JP); Shinji Uchiyama, Yokohama-shi (JP)

(72) Inventors: Keisuke Tateno, Kawasaki-shi (JP); Daisuke Kotake, Yokohama-shi (JP); Shinji Uchiyama, Yokohama-shi (JP)

(73) Assignee: CANON KABUSHIKI KAISHA, Tokyo (JP)

(21) Appl. No.: 13/885,965

(22) PCT Filed: Nov. 15, 2011
(86) PCT No.: PCT/JP2011/006352

§ 371 Date: May 16, 2013

(30) Foreign Application Priority Data
Nov. 19, 2010 (JP) 2010-259420

(51) Int. Cl. G06T 19/00

(52) U.S. Cl. CPC G06T 19/003
USPC 382/154

(57) ABSTRACT

An information processing apparatus according to the present invention includes a three-dimensional model storage unit configured to store data of a three-dimensional model that describes a geometric feature of an object, a two-dimensional image input unit configured to input a two-dimensional image in which the object is imaged, a range image input unit configured to input a range image in which the object is imaged, an image feature detection unit configured to detect an image feature from the two-dimensional image input from the two-dimensional image input unit, an image feature three-dimensional information calculation unit configured to calculate three-dimensional coordinates corresponding to the image feature from the range image input from the range image input unit, and a model fitting unit configured to fit the three-dimensional model into the three-dimensional coordinates of the image feature.

### TECHNICAL FIELD

The present invention relates to a technology for measuring the position and orientation of an object whose three-dimensional model is known.

### BACKGROUND ART

Along with the development of robot technologies in recent years, robots are replacing humans in performing complicated tasks such as assembly of industrial products. Such robots grip components with hands and other end effectors for assembly. In order for a robot to grip a component, it is necessary to measure a relative position and orientation between the component to be gripped and the robot (hand). The position and orientation are typically measured by a model fitting method which fits a three-dimensional shape model of an object into features that are detected from a gray-scale image captured by a camera or a range image that is obtained from a range sensor.

For example, T. Drummond and R. Cipolla, “Real-time visual tracking of complex structures,” IEEE Transactions on Pattern Analysis and Machine Intelligence, vol. 24, no. 7, pp. 932-946, 2002 discusses a method of using edges as the features to be detected from a gray-scale image. According to the method, the shape of an object is expressed by a set of three-dimensional lines. A general position and orientation of the object are assumed to be known. The position and orientation of the object are measured by correcting the general position and orientation so that projected images of the three-dimensional lines fit into edges that are detected from a gray-scale image in which the object is imaged.

In the foregoing conventional technology, a model is fitted into image features detected from a gray-scale image to minimize distances on the image. Accordingly, changes in a depth direction are typically difficult to estimate accurately since such changes are small in appearance in the depth direction. Since a model is fitted into two-dimensionally adjacent features, some features can be erroneously dealt with, which makes position and orientation estimation unstable if the features are two-dimensionally adjacent, yet wide apart in the depth direction.

There are methods of performing position and orientation estimation on a range image. An example is the technology discussed in P. J. Besl and N. D. McKay, “A method for registration of 3-D shapes,” IEEE Transactions on Pattern Analysis and Machine Intelligence, vol. 14, no. 2, pp. 239-256, 1992. From such methods utilizing a range image, it is readily conceivable to simply extend the foregoing conventional technology into a method of using a range image and process a range image instead of a gray-scale image. Since image features are detected by regarding a range image as a gray-scale image, image features with known three-dimensional coordinates can be obtained. This can directly minimize errors between the image features and a model in a three-dimensional space. Thus, as compared to the conventional technology, accurate estimation is possible even in the depth direction. Since the fitting is performed on image features that are three-dimensionally adjacent to the model, it is possible to properly handle features that are two-dimensionally adjacent, yet wide apart in the depth direction, which is a problem in the conventional technology.

Such a technique, however, can detect image features even from noise in the range image. There is thus a problem that position and orientation estimation may fail by erroneously dealing with noise-based image features if the range image contains noise.

In practical use, the problem is quite serious since a range image often contains noise due to multiple reflections in regions or at boundaries between planes where distances change discontinuously. In addition, when image features are detected from a range image, it is not possible to make use of image features arising from the texture of the target object for position and orientation estimation. The accuracy of model fitting increases as an amount of information increases. It is preferred that texture information about the target object, if any, can be used for position and orientation estimation.

### CITATION LIST

### Non Patent Literature

NPL 1: T. Drummond and R. Cipolla, “Real-time visual tracking of complex structures,” IEEE Transactions on Pattern Analysis and Machine Intelligence, vol. 24, no. 7, pp. 932-946, 2002
NPL 2: P. J. Besl and N. D. McKay, “A method for registration of 3-D shapes,” IEEE Transactions on Pattern Analysis and Machine Intelligence, vol. 14, no. 2, pp. 239-256, 1992

### SUMMARY OF INVENTION

The present invention is directed to performing high-accuracy model fitting that is less susceptible to noise in a range image.

According to an aspect of the present invention, an information processing apparatus includes a three-dimensional model storage unit configured to store data of a three-dimensional model that describes a geometric feature of an object, a two-dimensional image input unit configured to input a two-dimensional image in which the object is imaged, a range image input unit configured to input a range image in which the object is imaged, an image feature detection unit configured to detect an image feature from the two-dimensional image input from the two-dimensional image input unit, an image feature three-dimensional information calculation unit configured to calculate three-dimensional coordinates corresponding to the image feature from the range image input from the range image input unit, and a model fitting unit configured to fit the three-dimensional model into the three-dimensional coordinates of the image feature.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic diagram illustrating an example of the general configuration of an information processing system that includes an information processing apparatus according to a first exemplary embodiment of the present invention.

FIG. 2A is a schematic diagram illustrating the first exemplary embodiment of the present invention, describing a method of defining a three-dimensional model.

FIG. 2B is a schematic diagram illustrating the first exemplary embodiment of the present invention, describing a method of defining a three-dimensional model.

FIG. 2C is a schematic diagram illustrating the first exemplary embodiment of the present invention, describing a method of defining a three-dimensional model.

FIG. 2D is a schematic diagram illustrating the first exemplary embodiment of the present invention, describing a method of defining a three-dimensional model.

FIG. 3 is a flowchart illustrating an example of the processing procedure of a position and orientation estimation method (information processing method) of the information processing apparatus according to the first exemplary embodiment of the present invention.

FIG. 4 is a flowchart illustrating an example of detailed processing in which an image feature detection unit according to the first exemplary embodiment of the present invention detects edge features from a gray-scale image.

FIG. 5A is a schematic diagram describing the edge detection according to the first exemplary embodiment of the present invention.

FIG. 5B is a schematic diagram describing the edge detection according to the first exemplary embodiment of the present invention.

FIG. 6 is a schematic diagram illustrating the first exemplary embodiment of the present invention, describing a relationship between the three-dimensional coordinates of an edge and a line segment of a three-dimensional model.

FIG. 7 is a schematic diagram illustrating an example of the general configuration of an information processing system (model collation system) that includes an information processing apparatus (model collation apparatus) according to a second exemplary embodiment of the present invention.

FIG. 8 is a flowchart illustrating an example of the processing for position and orientation estimation (information processing method) of the information processing apparatus according to the second exemplary embodiment of the present invention.

FIG. 9 is a schematic diagram illustrating an example of the general configuration of an information processing system that includes an information processing apparatus according to a third exemplary embodiment of the present invention.

FIG. 10 is a flowchart illustrating an example of the processing for position and orientation estimation (information processing method) of the information processing apparatus according to the third exemplary embodiment of the present invention.

FIG. 11 is a schematic diagram illustrating an example of the general configuration of an information processing system that includes an information processing apparatus according to a fourth exemplary embodiment of the present invention.

### DESCRIPTION OF EMBODIMENTS

Various exemplary embodiments, features, and aspects of the invention will be described in detail below with reference to the drawings.

According to the present first exemplary embodiment, an information processing apparatus according to an exemplary embodiment of the present invention is applied to a method of estimating the position and orientation of an object by using a three-dimensional shape model, a gray-scale image, and a range image. The first exemplary embodiment is based on the assumption that a general position and orientation of the object are known.

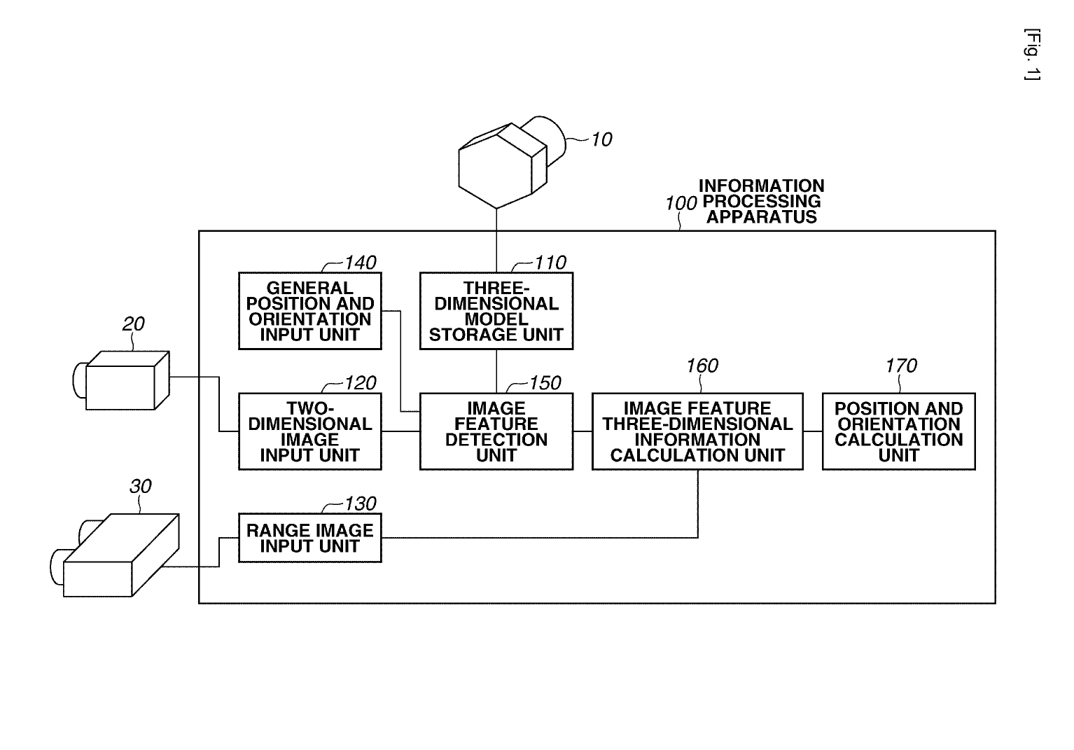

FIG. 1 is a schematic diagram illustrating an example of the general configuration of an information processing system that includes the information processing apparatus according to the first exemplary embodiment of the present invention.

As illustrated in FIG. 1, the information processing system includes a three-dimensional model (also referred to as a three-dimensional shape model) 10, a two-dimensional image capturing apparatus 20, a three-dimensional data measurement apparatus 30, and an information processing apparatus 100.

The information processing apparatus 100 according to the present exemplary embodiment performs position and orientation estimation by using data of the three-dimensional model 10 which expresses the shape of an object to be observed.

The information processing apparatus 100 includes a three-dimensional model storage unit 110, a two-dimensional image input unit 120, a range image input unit 130, a general position and orientation input unit 140, an image feature detection unit 150, an image feature three-dimensional information calculation unit 160, and a position and orientation calculation unit 170.

The two-dimensional image capturing apparatus 20 is connected to the two-dimensional image input unit 120.

The two-dimensional image capturing apparatus 20 is a camera that captures an ordinary two-dimensional image. The two-dimensional image to be captured may be a gray-scale image or a color image. In the present exemplary embodiment, the two-dimensional image capturing apparatus 20 outputs a gray-scale image. The image captured by the two-dimensional image capturing apparatus 20 is input to the information processing apparatus 100 through the two-dimensional image input unit 120. Internal parameters of the camera, such as focal length, principal point position, and lens distortion parameters, are calibrated in advance, for example, by a method that is discussed in R. Y. Tsai, “A versatile camera calibration technique for high-accuracy 3D machine vision metrology using off-the-shelf TV cameras and lenses,” IEEE Journal of Robotics and Automation, vol. RA-3, no. 4, 1987.

The three-dimensional data measurement apparatus 30 is connected to the range image input unit 130.

The three-dimensional data measurement apparatus 30 measures three-dimensional information about points on the surface of an object to be measured. The three-dimensional data measurement apparatus 30 is composed of a range sensor that outputs a range image. A range image is an image whose pixels have depth information. The present exemplary embodiment uses a range sensor of active type which irradiates an object with laser light, captures the reflected light with a camera, and measures distance by triangulation. The range sensor, however, is not limited thereto and may be of time-of-flight type which utilizes the time of flight of light. A range sensor of passive type may be used, which calculates the depth of each pixel by triangulation from images captured by a stereo camera. Range sensors of any type may be used without impairing the gist of the present invention as long as the range sensors can obtain a range image. Three-dimensional data measured by the three-dimensional data measurement apparatus 30 is input to the information processing apparatus 100 through the range image input unit 130. The optical axis of the three-dimensional data measurement apparatus 30 coincides with that of the two-dimensional image capturing apparatus 20. The correspondence between the pixels of a two-dimensional image output by the two-dimensional image capturing apparatus 20 and those of a range image output by the three-dimensional data measurement apparatus 30 is known.

The three-dimensional model storage unit 110 stores the data of the three-dimensional model 10 which describes geometric features of the object to be observed. The three-dimensional model storage unit 110 is connected to the image feature detection unit 150.

The data of the three-dimensional model 10, stored in the three-dimensional model storage unit 110, describes the shape of the object to be observed. Based on the data of the three-dimensional model, the information processing apparatus 100 measures the position and orientation of the object to be observed that is imaged in the two-dimensional image and the range image. Note that the present exemplary embodiment is applicable to the information processing apparatus 100 on the condition that the data of the three-dimensional model 10, stored in the three-dimensional model storage unit 110, conforms to the shape of the object to be observed that is actually imaged.

The three-dimensional model storage unit 110 stores the data of the three-dimensional model (three-dimensional shape model) 10 of the object that is the subject of the position and orientation measurement. The three-dimensional model (three-dimensional shape model) 10 is used when the position and orientation calculation unit 170 calculates the position and orientation of the object. In the present exemplary embodiment, an object is described as a three-dimensional model (three-dimensional shape model) 10 that is composed of line segments and planes. A three-dimensional model (three-dimensional shape model) 10 is defined by a set of points and a set of line segments that connect the points.

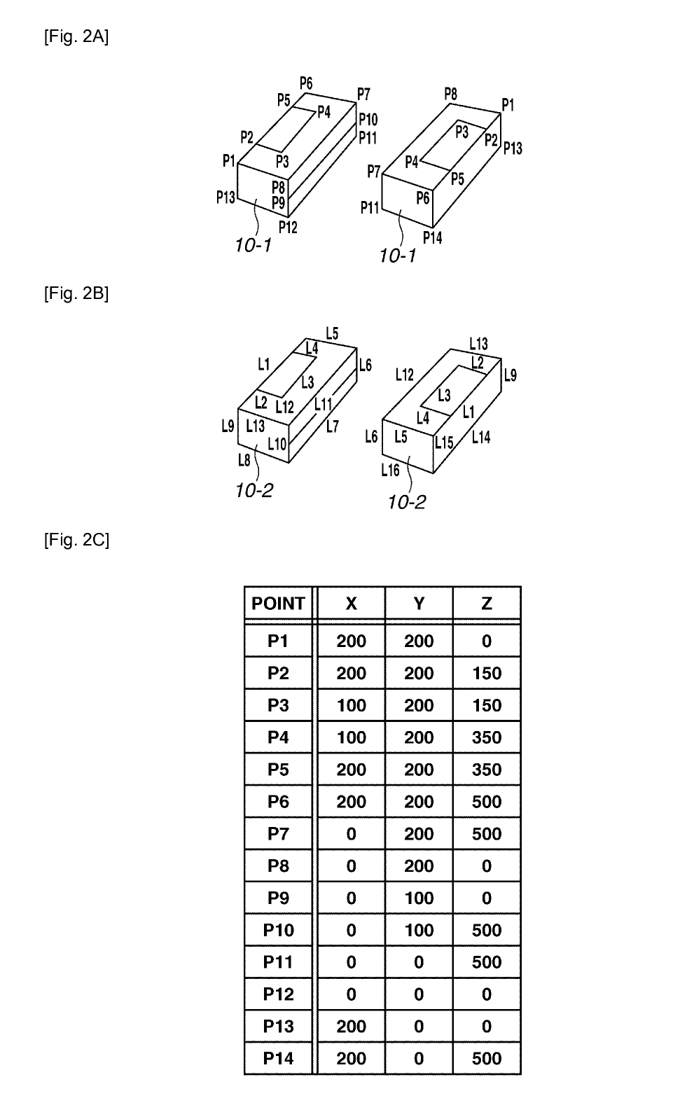

FIGS. 2A to 2D are schematic diagrams illustrating the first exemplary embodiment of the present invention, describing a method of defining a three-dimensional model 10. A three-dimensional model 10 is defined by a set of points and a set of line segments that connect the points. As illustrated in FIG. 2A, a three-dimensional model 10-1 includes 14 points P1 to P14. As illustrated in FIG. 2B, a three-dimensional model 10-2 includes line segments L1 to L16. As illustrated in FIG. 2C, the points P1 to P14 are expressed by three-dimensional coordinate values. As illustrated in FIG. 2D, the line segments L1 to L16 are expressed by the IDs of points that constitute the line segments.

The two-dimensional image input unit 120 inputs the two-dimensional image captured by the two-dimensional image capturing apparatus 20 to the information processing apparatus 100.

The range image input unit 130 inputs the range image measured by the three-dimensional data measurement apparatus 30 to the information processing apparatus 100, which is a position and orientation measurement apparatus. The image capturing of the camera and the range measurement of the range sensor are assumed to be performed at the same time. It is not necessary, however, to simultaneously perform the image capturing and the range measurement if the information processing apparatus 100 and the object to be observed remain unchanged in position and orientation, such as when the target object remains stationary.

The two-dimensional image input from the two-dimensional image input unit 120 and the range image input from the range image input unit 130 are captured from approximately the same viewpoints. The correspondence between the images is known.

The general position and orientation input unit 140 inputs general values of the position and orientation of the object with respect to the information processing apparatus 100. The position and orientation of an object with respect to the information processing apparatus 100 refer to the position and orientation of the object in a camera coordinate system of the two-dimensional image capturing apparatus 20 for capturing a gray-scale image. The position and orientation of an object, however, may be expressed with reference to any part of the information processing apparatus 100, which is the position and orientation measurement apparatus, as long as the relative position and orientation with respect to the camera coordinate system are known and unchanging. In the present exemplary embodiment, the information processing apparatus 100 makes measurements consecutively in a time-axis direction.

The information processing apparatus 100 then uses previous measurement values (measurement values at the previous time) as the general position and orientation. However, the method of inputting general values of the position and orientation is not limited thereto. For example, a time-series filter may be used to estimate the velocity and angular velocity of an object from past measurements in position and orientation, and the current position and orientation may be predicted from the past position, the past orientation, and the estimated velocity and angular velocity. Alternatively, images of a target object may be captured in various orientations and retained as templates. Then, an input image may be subjected to template matching to estimate a rough position and orientation of the target object.

If other sensors are available to measure the position and orientation of an object, the output values of those sensors may be used as the general values of the position and orientation. Examples of the sensors include a magnetic sensor, in which a transmitter emits a magnetic field and a receiver attached to the object detects the magnetic field to measure the position and orientation. An optical sensor may be used, in which markers arranged on the object are captured by a scene-fixed camera for position and orientation measurement. Any other sensors may be used as long as the sensors measure a position and orientation with six degrees of freedom. If a rough position and orientation where the object is placed is known in advance, such values are used as the general values.

The image feature detection unit 150 detects image features from the two-dimensional image input from the two-dimensional image input unit 120. In the present exemplary embodiment, the image feature detection unit 150 detects edges as the image features.

The image feature three-dimensional information calculation unit 160 calculates the three-dimensional coordinates of edges detected by the image feature detection unit 150 in the camera coordinate system by referring to the range image input from the range image input unit 130. The method of calculating three-dimensional information about image features will be described later.

The position and orientation calculation unit 170 calculates the position and orientation of the object based on the three-dimensional information about the image features calculated by the image feature three-dimensional information calculation unit 160. The position and orientation calculation unit 170 constitutes a “model application unit” which applies a three-dimensional model to the three-dimensional coordinates of image features. Specifically, the position and orientation calculation unit 170 calculates the position and orientation of the object so that differences between the three-dimensional coordinates of the image features and the three-dimensional model fall within a predetermined value.

Next, the processing for position and orientation estimation according to the present exemplary embodiment will be described.

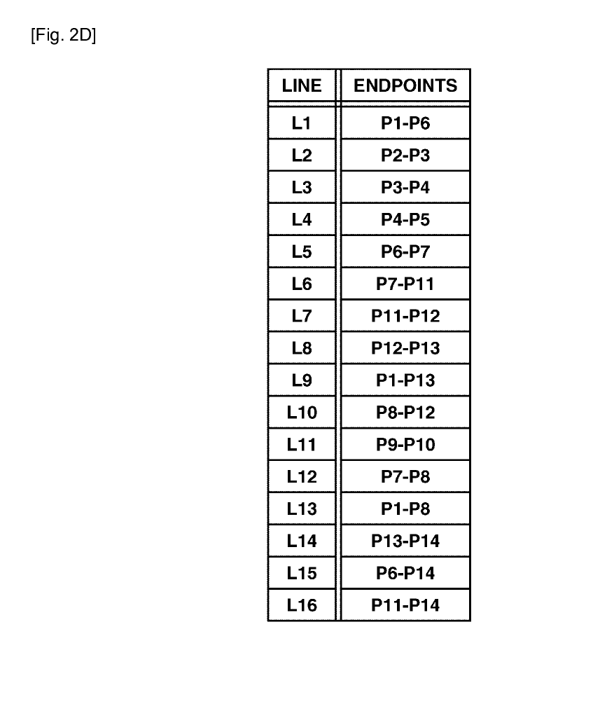

FIG. 3 is a flowchart illustrating an example of the processing for the position and orientation estimation (information processing method) of the information processing apparatus 100 according to the first exemplary embodiment of the present invention.

In step S1010, the information processing apparatus 100 initially performs initialization. The general position and orientation input unit 140 inputs general values of the position and orientation of the object with respect to the information processing apparatus 100 (camera) into the information processing apparatus 100. The method of measuring a position and orientation according to the present exemplary embodiment includes updating the general position and orientation of the object in succession based on measurement data. This requires that a general position and orientation of the two-dimensional image capturing apparatus 20 be given as an initial position and initial orientation in advance before the start of position and orientation measurement. As mentioned previously, the present exemplary embodiment uses the position and orientation measured at the previous time.

In step S1020, the two-dimensional image input unit 120 and the range image input unit 130 acquire measurement data for calculating the position and orientation of the object by model fitting. Specifically, the two-dimensional image input unit 120 acquires a two-dimensional image (gray-scale image) of the object to be observed from the two-dimensional image capturing apparatus 20, and inputs the two-dimensional image into the information processing apparatus 100. The range image input unit 130 acquires a range image from the three-dimensional data measurement apparatus 30, and inputs the range image into the information processing apparatus 100. In the present exemplary embodiment, a range image contains distances from the camera to points on the surface of the object to be observed. As mentioned previously, the optical axes of the two-dimensional image capturing apparatus 20 and the three-dimensional data measurement apparatus 30 coincide with each other. The correspondence between the pixels of the gray-scale image and those of the range image is thus known.

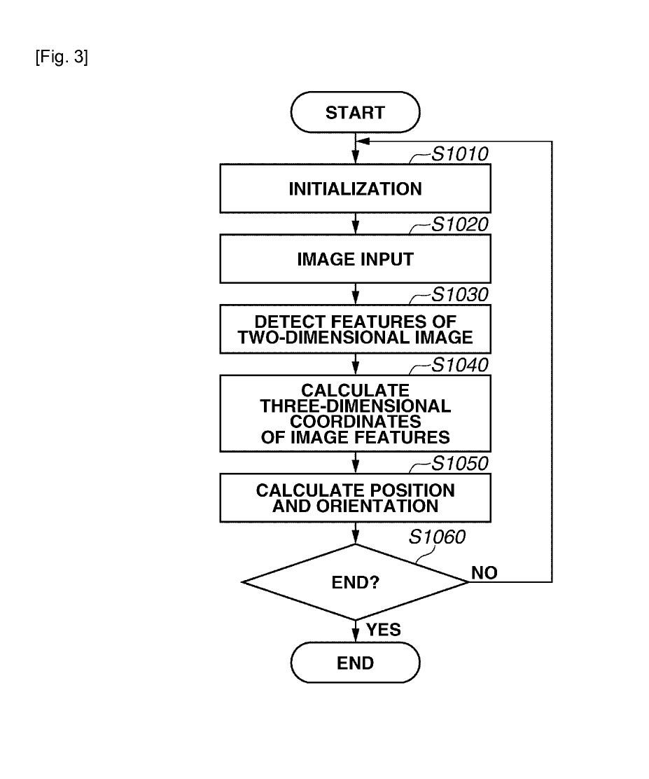

In step S1030, the image feature detection unit 150 detects image features to be associated with the three-dimensional model (three-dimensional shape model) 10 from the gray-scale image that is input in step S1020. In the present exemplary embodiment, the image feature detection unit 150 detects edges as the image features. Edges refer to points where the density gradient peaks. In the present exemplary embodiment, the image feature detection unit 150 carries out edge detection by the method that is discussed in T. Drummond and R. Cipolla, “Real-time visual tracking of complex structures,” IEEE Transactions on Pattern Analysis and Machine Intelligence, vol. 24, no. 7, pp. 932-946, 2002. FIG. 4 is a flowchart illustrating an example of detailed processing in which the image feature detection unit 150 according to the first exemplary embodiment of the present invention detects edge features from a grayscale image.

In step S1110, the image feature detection unit 150 projects the three-dimensional model (three-dimensional shape model) 10 onto an image plane by using the general position and orientation of the object to be observed that are input in step S1010 and the internal parameters of the two-dimensional image capturing apparatus 20. The image feature detection unit 150 thereby calculates the coordinates and direction of each line segment on the two-dimensional image that constitutes the three-dimensional model (three-dimensional shape model) 10. The projection images of the line segments are line segments again.

In step S1120, the image feature detection unit 150 sets control points on the projected line segments calculated in step S1110. The control points refer to points on three-dimensional lines, which are set to divide the projected line segments at equal intervals. Hereinafter, such control points will be referred to as edgelets. An edgelet retains information about three-dimensional coordinates, a three-dimensional direction of a line segment, and two-dimensional coordinates and a two-dimensional direction that are obtained as a result of projection. The greater the number of edgelets, the longer the processing time. Accordingly, the intervals between edgelets may be successively modified so as to make the total number of edgelets constant. Specifically, in step S1120, the image feature detection unit 150 divides the projected line segments for edgelet calculation.

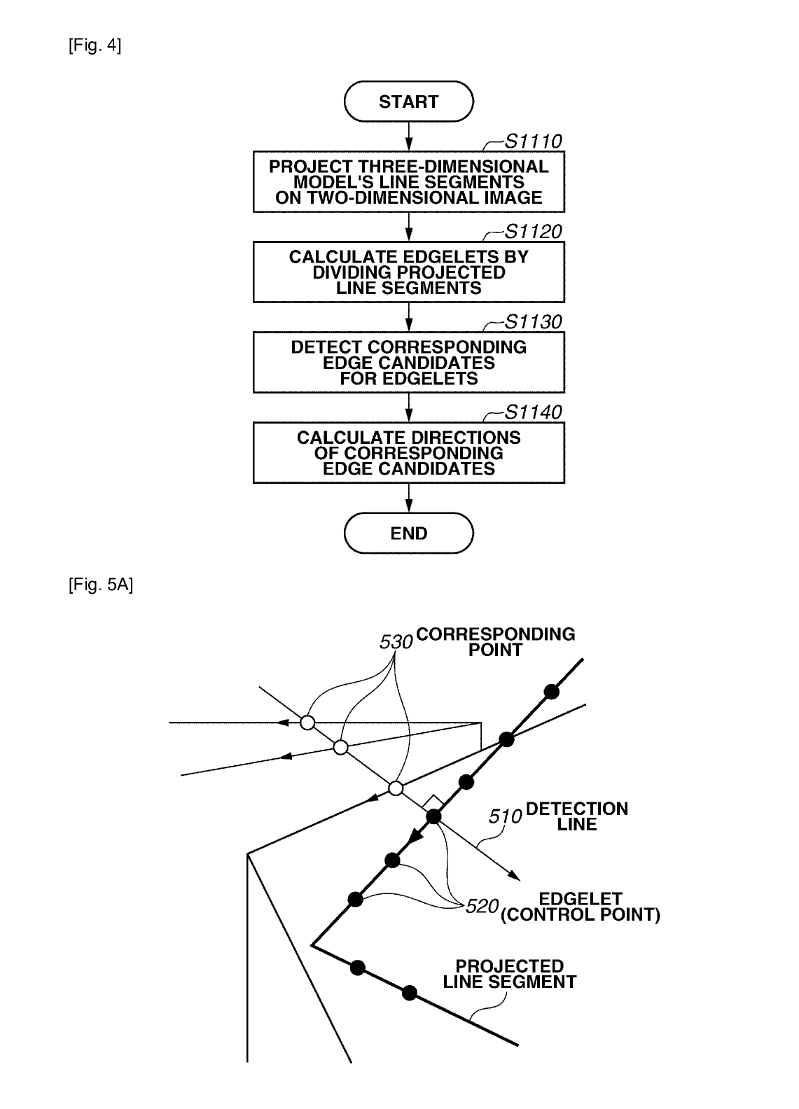

In step S1130, the image feature detection unit 150 detects edges in the two-dimensional image, which correspond to the edgelets determined in step S1120. FIGS. 5A and 5B are schematic diagrams for describing the edge detection according to the first exemplary embodiment of the present invention.

The image feature detection unit 150 detects edges by calculating extreme values on a detection line 510 of an edgelet (in a direction normal to two-dimensional direction of control points 520) based on density gradients on the captured image. Edges lie in positions where the density gradient peaks on the detection line 510 (FIG. 5B). The image feature detection unit 150 stores the two-dimensional coordinates of all the edges detected on the detection line 510 of the edgelet 520 as corresponding point candidates of the edgelet 520. The image feature detection unit 150 repeats the foregoing processing on all the edgelets. In step S1140, the image feature detection unit 150 then calculates the directions of the corresponding candidate edges. After completing the processing of step S1140, the image feature detection unit 150 ends the processing of step S1030. The processing proceeds to step S1040.

In step S1040 of FIG. 3, the image feature three-dimensional information calculation unit 160 refers to the range image and calculates the three-dimensional coordinates of corresponding points 530 in order to calculate three-dimensional errors between the edgelets determined in step S1020 and the corresponding points 530. In other words, the image feature three-dimensional information calculation unit 160 calculates the three-dimensional coordinates of the image features.

The image feature three-dimensional information calculation unit 160 initially selects a corresponding point candidate to be processed from among the corresponding point candidates of the edgelets. Next, the image feature three-dimensional information calculation unit 160 calculates the three-dimensional coordinates of the selected corresponding point candidate. In the present exemplary embodiment, the gray-scale image and the range image are coaxially captured. The image feature three-dimensional information calculation unit 160 therefore simply employs the two-dimensional coordinates of the corresponding coordinate point candidate calculated in step S1030 as the two-dimensional coordinates on the range image.

The image feature three-dimensional information calculation unit 160 refers to the range image for a distance value corresponding to the two-dimensional coordinates of the corresponding point candidate. The image feature three-dimensional information calculation unit 160 then calculates the three-dimensional coordinates of the corresponding point candidate from the two-dimensional coordinates and the distance value of the corresponding point candidate. Specifically, the image feature three-dimensional information calculation unit 160 calculates at least one or more sets of three-dimensional coordinates of an image feature by referring to the range image for distance values within a predetermined range around the position where the image feature is detected. The image feature three-dimensional information calculation unit 160 may refer to the range image for distance values within a predetermined range around the position of detection of an image feature and calculate three-dimensional coordinates so that the distance between the three-dimensional coordinates of the image feature and the three-dimensional model 10 falls within a predetermined value.

The three-dimensional coordinates are given by the following equation (1):

$$\begin{matrix}Math .1 & \\ X = Z \frac{( ux - cx )}{f} , Y = Z \frac{( uy - cx )}{f} , Z = depth & ( 1 )\end{matrix}$$

where depth is the distance value determined from the range image, and X, Y, Z are the three-dimensional coordinates.

In equation (1), f is the focal length, (ux, uy) are the two-dimensional coordinates on the range image, and (cx, cy) are camera's internal parameters that represent the image center. From the equation (1), the image feature three-dimensional information calculation unit 160 calculates the three-dimensional coordinates of the corresponding point candidate. The image feature three-dimensional information calculation unit 160 repeats the foregoing processing on all the corresponding point candidates of all the edgelets. After completing the processing of calculating the three-dimensional coordinates of the corresponding point candidates, the image feature three-dimensional information calculation unit 160 ends the processing of step S1040. The processing proceeds to step S1050.

In step S1050, the position and orientation calculation unit 170 calculates the position and orientation of the object to be observed by correcting the general position and orientation of the object to be observed so that the three-dimensional shape model 30 fits into the measurement data in a three-dimensional space. To perform the correction, the position and orientation calculation unit 170 performs iterative operations using nonlinear optimization calculation. In the present step, the position and orientation calculation unit 170 uses the Gauss-Newton method as the nonlinear optimization technique. The nonlinear optimization technique is not limited to the Gauss-Newton method. For example, the position and orientation calculation unit 170 may use the Levenberg-Marquardt method for more robust calculation. The steepest-descent method, a simpler method, may be used. The position and orientation calculation unit 170 may use other nonlinear optimization calculation techniques such as the conjugate gradient method and the incomplete Cholesky-conjugate gradient (ICCG) method. The position and orientation calculation unit 170 optimizes the position and orientation based on the distances between the three-dimensional coordinates of the edges calculated in step S1040 and the line segments of the three-dimensional model that is converted into the camera coordinate system based on the estimated position and orientation.

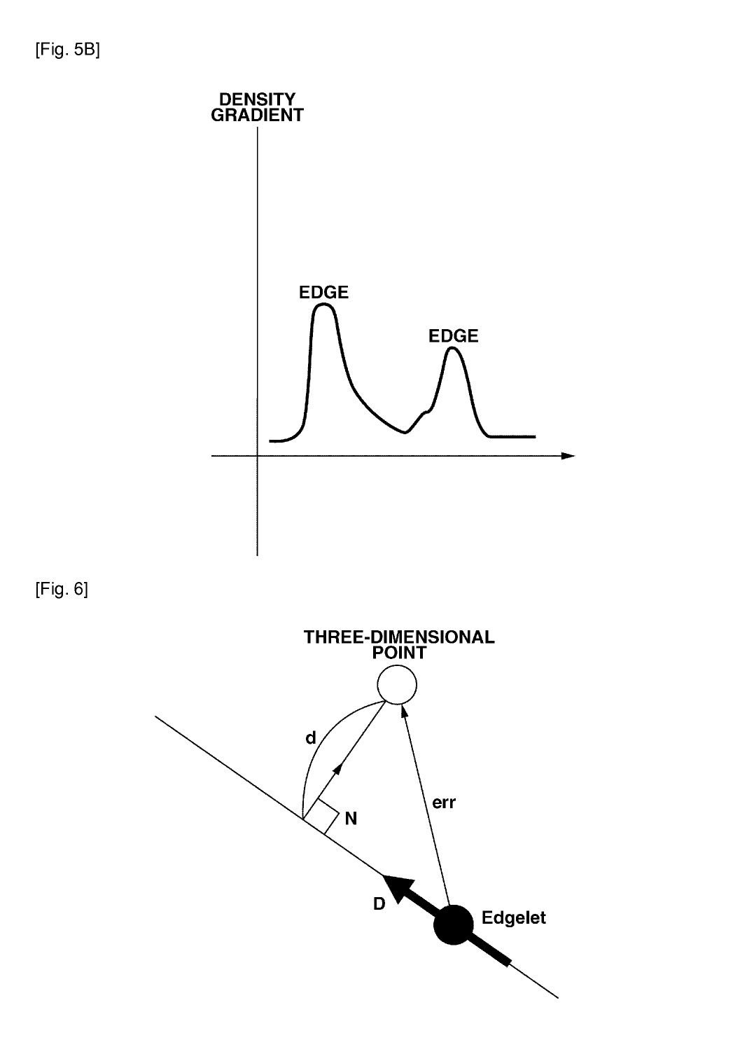

FIG. 6 is a schematic diagram illustrating the first exemplary embodiment of the present invention, describing a relationship between the three-dimensional coordinates of an edge and a line segment of a three-dimensional model. The signed distance d is given by the following equations (2) and (3):

$$\begin{matrix}Math .2 & \\ d = err \cdot N & ( 2 ) \\ Math .3 & \\ N = \frac{err - ( D \cdot err ) D}{\vert err - ( D \cdot err ) D \vert} & ( 3 )\end{matrix}$$

where err is the error vector between the three-dimensional coordinates of the corresponding point candidate and those of the edgelet, N is the vector (unit vector) normal to a line that passes the edgelet, which is the closest to the corresponding point candidate, and D is the directional vector (unit vector) of the edgelet.

The position and orientation calculation unit 170 linearly approximates the signed distance d to a function of minute changes in position and orientation, and formulates linear equations on each piece of measurement data so as to make the signed distance zero. The position and orientation calculation unit 170 solves the linear equations as simultaneous equations to determine minute changes in the position and orientation of the object, and corrects the position and orientation. The position and orientation calculation unit 170 repeats the foregoing processing to calculate a final position and orientation. The error minimization processing is irrelevant to the gist of the present invention. Description thereof will thus be omitted.

In step S1060, the information processing apparatus 100 determines whether there is an input to end the calculation of the position and orientation. If it is determined that there is an input to end the calculation of the position and orientation (YES in step S1060), the information processing apparatus 100 ends the processing of the flowchart. On the other hand, if there is no input to end the calculation of the position and orientation (NO in step S1060), the information processing apparatus 100 returns to step S1010 to acquire new images and calculate the position and orientation again.

According to the present exemplary embodiment, the information processing apparatus 100 detects edges from a gray-scale image and calculates the three-dimensional coordinates of the detected edges from a range image. This enables stable position and orientation estimation with high accuracy in the depth direction, which is unsusceptible to noise in the range image. Since that are undetectable from a range image edges can be detected from a gray-scale image, it is possible to estimate a position and orientation with high accuracy by using a greater amount of information.

Next, modifications of the first exemplary embodiment of the present invention will be described.

A first modification deals with the case of calculating the three-dimensional coordinates of a corresponding point by referring to adjacent distance values. In the first exemplary embodiment, the three-dimensional coordinates of an image feature are calculated by using a distance value corresponding to the two-dimensional position of the image feature. However, the method of calculating the three-dimensional coordinates of an image feature is not limited thereto. For example, the vicinity of the two-dimensional position of an image feature may be searched to calculate a median of a plurality of distance values and calculate the three-dimensional coordinates of the edge. Specifically, the image feature three-dimensional information calculation unit 160 may refer to all the distance values of nine adjacent pixels around the two-dimensional position of an image feature, and calculate the three-dimensional coordinates of the image feature by using a median of the distance values.

The image feature three-dimensional information calculation unit 160 may independently determine three-dimensional coordinates of the image feature from the respective adjacent distance values, and determine three-dimensional coordinates that minimize the distance to the edgelet as the three-dimensional coordinates of the image feature. Such methods are effective when jump edges in the range image contain a large amount of noise. The method of calculating three-dimensional coordinates is not limited to the foregoing. Any technique may be used as long as the three-dimensional coordinates of an image feature can be calculated.

A second modification deals with the use of non-edge features. In the first exemplary embodiment, edges detected from a gray-scale image are associated with three-dimensional lines of a three-dimensional model. However, the features to be associated are not limited to edges on an image. For example, point features where luminance varies characteristically may be detected as image features. The three-dimensional coordinates of the point features may then be calculated from a range image and associated with three-dimensional points that are stored as a three-dimensional model in advance. Feature expression is not particularly limited as long as features can be detected from a gray-scale image and their correspondence with a three-dimensional model is computable.

A third modification deals with the use of plane-based features. In the first exemplary embodiment, edges detected from a gray-scale image are associated with three-dimensional lines of a three-dimensional model. However, the features to be associated are not limited to edges on an image. For example, plane regions which can be stably detected may be detected as image features. Specifically, a region detector based on image luminance may be used to detect plane regions which show stable changes in viewpoint and luminance. The three-dimensional coordinates of the plane regions and the three-dimensional normals to the planes may then be calculated from a range image and associated with three-dimensional planes of a three-dimensional model. An example of the technique for region detection includes a region detector based on image luminance that is discussed in J. Matas, O. Chum, M. Urba, and T. Pajdla, “Robust wide baseline stereo from maximally stable extremal regions,” Proc. of British Machine Vision Conference, pages 384-396, 2002.

The normal to three-dimensional plane and the three-dimensional coordinates of a plane region may be calculated, for example, by referring to a range image for the distance values of three points within the plane region in a gray-scale image. Then, the normal to the three-dimensional plane can be calculated by determining an outer product of the three points. The three-dimensional coordinates of the three-dimensional plane can be calculated from a median of the distance values. The method of detecting a plane region from a gray-scale image is not limited to the foregoing. Any technique may be used as long as plane regions can be stably detected from a gray-scale image. The method of calculating the normal to the three-dimensional plane and the three-dimensional coordinates of a plane region is not limited to the foregoing. Any method may be used as long as the method can calculate three-dimensional coordinates and a three-dimensional normal from distance values corresponding to a plane region.

A fourth modification deals with a case where the viewpoints of the gray-scale image and the range image are not generally the same. The first exemplary embodiment has dealt with the case where the gray-scale image and the range image are captured from the same viewpoint and the correspondence between the images is known at the time of image capturing. However, the viewpoints of the gray-scale image and the range image need not be the same. For example, an image capturing apparatus that captures a gray-scale image and an image capturing apparatus that captures a range image may be arranged in different positions and/or orientations so that the gray-scale image and the range image are captured from different viewpoints respectively. In such a case, the correspondence between the gray-scale image and the range image is established by projecting a group of three-dimensional points in the range image onto the gray-scale image, assuming that the relative position and orientation between the image capturing apparatuses are known. The positional relationship between image capturing apparatuses for imaging an identical object are not limited to any particular one as long as the relative position and orientation between the image capturing apparatuses are known and the correspondence between their images is computable.

In the first exemplary embodiment, an exemplary embodiment of the present invention is applied to the estimation of object position and orientation. In the present second exemplary embodiment, an exemplary embodiment of the present invention is applied to object collation.

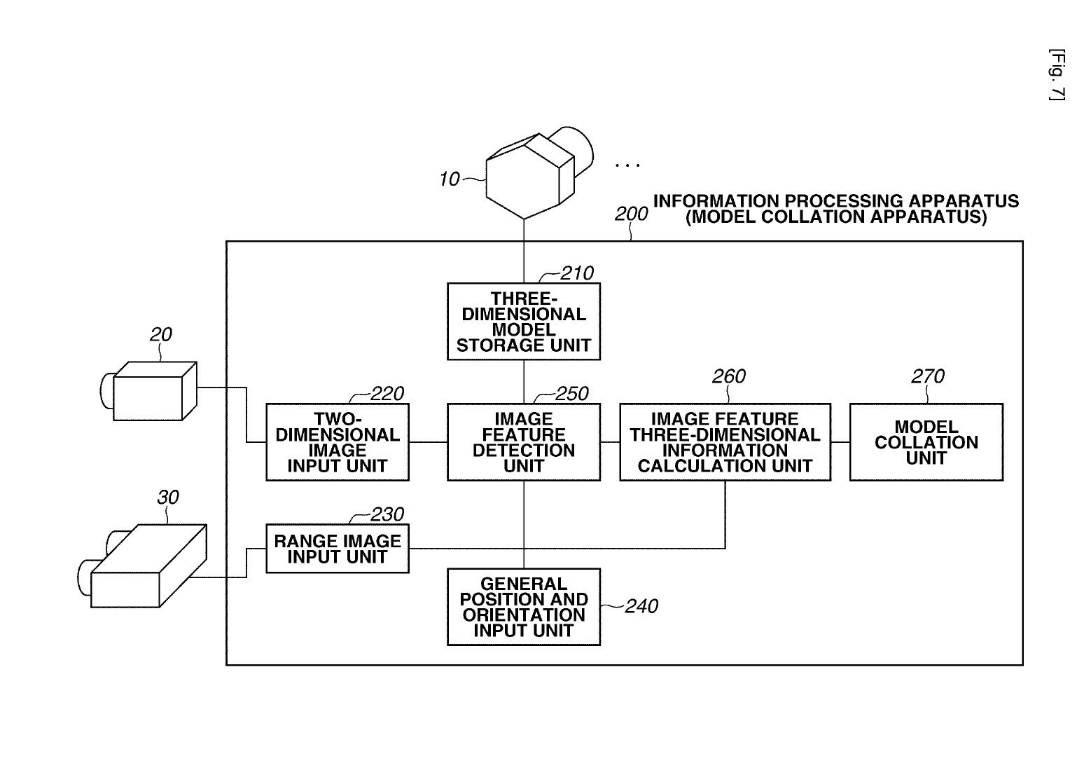

FIG. 7 is a schematic diagram illustrating an example of the general configuration of an information processing system (model collation system) that includes an information processing apparatus (model collation apparatus) according to the second exemplary embodiment of the present invention.

As illustrated in FIG. 7, the information processing system (model collation system) includes three-dimensional models (three-dimensional shape models) 10, a two-dimensional image capturing apparatus 20, a three-dimensional data measurement apparatus 30, and an information processing apparatus (model collation apparatus) 200.

The information processing apparatus 200 according to the present exemplary embodiment includes a three-dimensional model storage unit 210, a two-dimensional image input unit 220, a range image input unit 230, a general position and orientation input unit 240, an image feature detection unit 250, an image feature three-dimensional information calculation unit 260, and a model collation unit 270.

The two-dimensional image capturing apparatus 20 is connected to the two-dimensional image input unit 220. The three-dimensional data measurement apparatus 30 is connected to the range image input unit 230.

The three-dimensional model storage unit 210 stores data of the three-dimensional models 10. The three-dimensional model storage unit 210 is connected to the image feature detection unit 250. The data of the three-dimensional models 10, stored in the three-dimensional model storage unit 210, describes the shapes of objects to be observed. Based on the data of the three-dimensional models 10, the information processing apparatus (model collation apparatus) 200 determines whether an object to be observed is imaged in a two-dimensional image and a range image.

The three-dimensional model storage unit 210 stores the data of the three-dimensional models (three-dimensional shape models) 10 of objects to be collated. The method of retaining a three-dimensional shape model 10 is the same as the three-dimensional model storage unit 110 according to the first exemplary embodiment. In the present exemplary embodiment, the three-dimensional model storage unit 210 retains three-dimensional models (three-dimensional shape models) 10 as many as the number of objects to be collated.

The image feature three-dimensional information calculation unit 260 calculates the three-dimensional coordinates of edges detected by the image feature detection unit 250 by referring to a range image input from the range image input unit 230. The method of calculating three-dimensional information about image features will be described later.

The model collation unit 270 determines whether the images includes an object based on the three-dimensional positions and directions of image features calculated by the image feature three-dimensional information calculation unit 260. The model collation unit 270 constitutes a “model application unit” which fits a three-dimensional model into the three-dimensional coordinates of image features. Specifically, the model collation unit 270 measures degrees of mismatching between the three-dimensional coordinates of image features and three-dimensional models 30. The model collation unit 270 thereby performs collation for a three-dimensional model 30 that has a predetermined degree of mismatching or a lower degree.

The two-dimensional image input unit 220, the range image input unit 230, the general position and orientation input unit 240, and the image feature detection unit 250 are the same as the two-dimensional image input unit 120, the range image input unit 130, the general position and orientation input unit 140, and the image feature detection unit 150 according to the first exemplary embodiment, respectively. Description thereof will thus be omitted.

Next, the processing for a position and orientation estimation according to the present exemplary embodiment will be described.

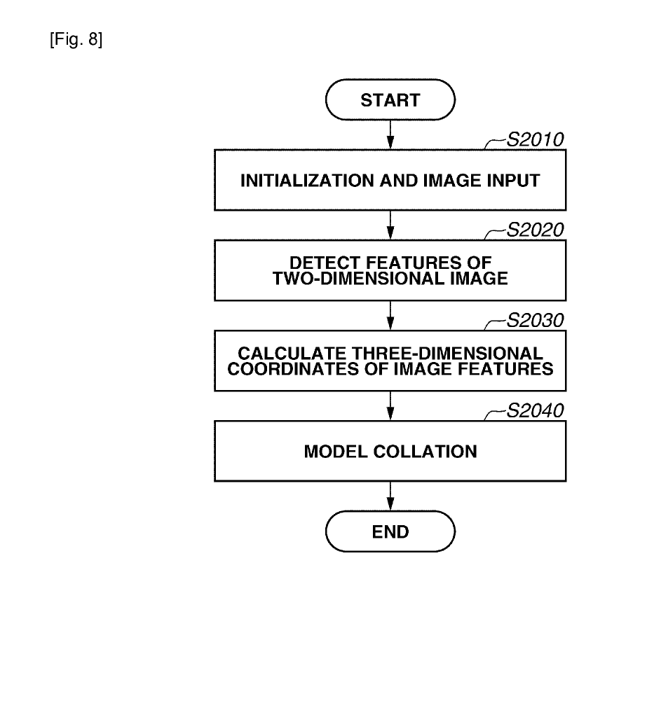

FIG. 8 is a flowchart illustrating an example of the processing for the position and orientation estimation (information processing method) of the information processing apparatus 200 according to the second exemplary embodiment of the present invention.

In step S2010, the information processing apparatus 200 initially performs initialization. The information processing apparatus 200 then acquires measurement data to be collated with the three-dimensional models (three-dimensional shape models) 10. Specifically, the two-dimensional image input unit 220 acquires a two-dimensional image (gray-scale image) of the object to be observed from the two-dimensional image capturing apparatus 20, and inputs the two-dimensional image into the information processing apparatus 200. The range image input unit 230 inputs a range image from the three-dimensional data measurement apparatus 30 into the information processing apparatus 200. The general position and orientation input unit 240 inputs a general position and orientation of the object. In the present exemplary embodiment, a rough position and orientation where the object is placed is known in advance. Such values are used as the general position and orientation of the object. The two-dimensional image and the range image are input by the same processing as that of step S1020 according to the first exemplary embodiment. Detailed description thereof will thus be omitted.

In step S2020, the image feature detection unit 250 detects image features from the gray-scale image input in step S2010. The image feature detection unit 250 detects image features with respect to each of the three-dimensional models (three-dimensional shape models) 10. The processing of detecting image features is the same as the processing of step S1030 according to the first exemplary embodiment. Detailed description thereof will thus be omitted. The image feature detection unit 250 repeats the processing of detecting image features for every three-dimensional model (three-dimensional shape model) 10. After completing the processing on all the three-dimensional models (three-dimensional shape models) 10, the image feature detection unit 250 ends the processing of step S2020. The processing proceeds to step S2030.

In step S2030, the image feature three-dimensional information calculation unit 260 calculates the three-dimensional coordinates of corresponding point candidates of the edgelets determined in step S2020. The image feature three-dimensional information calculation unit 260 performs the calculation of the three-dimensional coordinates on the edgelets of all the three-dimensional models (three-dimensional shape models) 10. The processing of calculating the three-dimensional coordinates of corresponding point candidates is the same as the processing of step S1040 according to the first exemplary embodiment. Detailed description thereof will thus be omitted. After completing the processing on all the three-dimensional models (three-dimensional shape models) 10, the image feature three-dimensional information calculation unit 260 ends the processing of step S2030. The processing proceeds to step S2040.

In step S2040, the model collation unit 270 calculates an amount of statistics of errors between edgelets and corresponding points in each of the three-dimensional models (three-dimensional shape models) 10. The model collation unit 270 thereby determines a three-dimensional model (three-dimensional shape model) 10 that is the most similar to the measurement data. As errors between a three-dimensional model (three-dimensional shape model) 10 and measurement data, in the present step, the model collation unit 270 determines the absolute values of distances between the three-dimensional coordinates of edges calculated in step S2030 and line segments of the three-dimensional model 10 that is converted into the camera coordinate system based on an estimated position and orientation. The distance between a line segment and a three-dimensional point is calculated by the same equation as described in step S1050. Detailed description thereof will thus be omitted. The model collation unit 270 calculates a median of the errors of each individual three-dimensional model (three-dimensional shape model) 10 as the amount of statistics, and retains the median as the degree of collation of the three-dimensional model (three-dimensional shape model) 10. The model collation unit 270 calculates the error statistics of all the three-dimensional models (three-dimensional shape models) 10, and determines a three-dimensional model (three-dimensional shape model) 10 that minimizes the error statistics. The model collation unit 270 thereby performs collation on the three-dimensional models (three-dimensional shape models) 10. Specifically, the model collation unit 270 performs collation so that differences between the three-dimensional coordinates of image features and a three-dimensional model 10 fall within a predetermined value. It should be noted that the error statistics may be other than a median of errors. For example, an average or mode value may be used. Any index may be used as long as the amount of errors can be determined.

According to the present exemplary embodiment, the information processing apparatus 200 refers to a range image for the three-dimensional coordinates of edges detected from a gray-scale image, and performs model collation based on correspondence between the three-dimensional coordinates of the edges and the three-dimensional models 10. This enables stable model collation even if the range image contains noise.

A third exemplary embodiment of the present invention deals with simultaneous extraction of image features from an image. The first and second exemplary embodiments have dealt with a method of performing model fitting on image features that are extracted from within the vicinity of a projected image of a three-dimensional model, based on a general position and orientation of an object. According to the present third exemplary embodiment, the present invention is applied to a method of extracting image features from an entire image at a time, attaching three-dimensional information to the image features based on a range image, and estimating the position and orientation of an object based on three-dimensional features and a three-dimensional model.

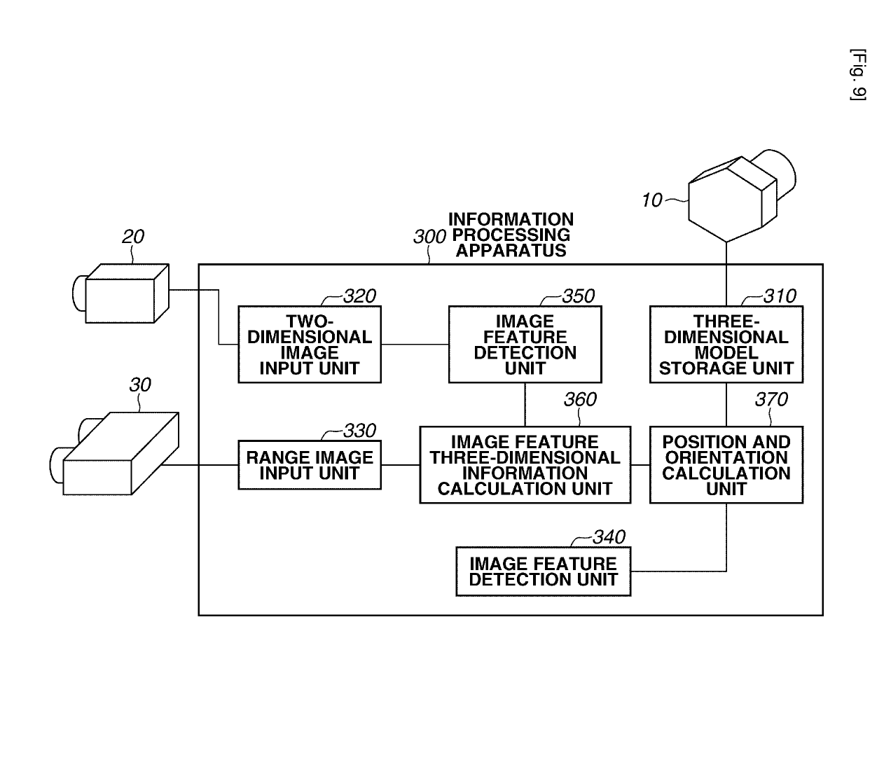

FIG. 9 is a schematic diagram illustrating an example of the general configuration of an information processing system (position and orientation estimation system) that includes an information processing apparatus (position and orientation estimation apparatus) according to the third exemplary embodiment of the present invention.

As illustrated in FIG. 9, the information processing system (position and orientation estimation system) includes a three-dimensional model (three-dimensional shape model) 10, a two-dimensional image capturing apparatus 20, a three-dimensional data measurement apparatus 30, and an information processing apparatus (position and orientation estimation apparatus) 300.

The information processing apparatus 300 according to the present exemplary embodiment includes a three-dimensional model storage unit 310, a two-dimensional image input unit 320, a range image input unit 330, a general position and orientation input unit 340, an image feature detection unit 350, an image feature three-dimensional information calculation unit 360, and a position and orientation calculation unit 370.

The two-dimensional image capturing apparatus 20 is connected to the two-dimensional image input unit 320. The three-dimensional data measurement apparatus 30 is connected to the range image input unit 330.

The three-dimensional model storage unit 310 stores data of the three-dimensional model 10. The three-dimensional model storage unit 310 is connected to the position and orientation calculation unit 370. The information processing apparatus (position and orientation estimation apparatus) 300 estimates the position and orientation of an object so as to fit into the object to be observed in a two-dimensional image and a range image, based on the data of the three-dimensional model 10 which is stored in the three-dimensional model storage unit 310. The data of the three-dimensional model 10 describes the shape of the object to be observed.

The image feature detection unit 350 detects image features from all or part of a two-dimensional image that is input from the two-dimensional image input unit 320. In the present exemplary embodiment, the image feature detection unit 350 detects edge features as the image features from the entire image. The processing of detecting line segment edges from an image will be described in detail later.

The image feature three-dimensional information calculation unit 360 calculates the three-dimensional coordinates of line segment edges detected by the image feature detection unit 350 by referring to a range image that is input from the range image input unit 330. The method of calculating three-dimensional information about image features will be described later.

The position and orientation calculation unit 370 calculates the three-dimensional position and orientation of the object to be observed based on the three-dimensional positions and directions of the image features calculated by the image feature three-dimensional information calculation unit 360 and the data of the three-dimensional model 10 which is stored in the three-dimensional model storage unit 310 and describes the shape of the object to be observed. The processing will be described in detail later.

The three-dimensional model storage unit 310, the two-dimensional image input unit 320, the range image input unit 330, and the general position and orientation input unit 340 are the same as the three-dimensional model storage unit 110, the two-dimensional image input unit 120, the range image input unit 130, and the general position and orientation input unit 140 according to the first exemplary embodiment, respectively. Description thereof will thus be omitted.

Next, the processing for position and orientation estimation according to the present exemplary embodiment will be described.

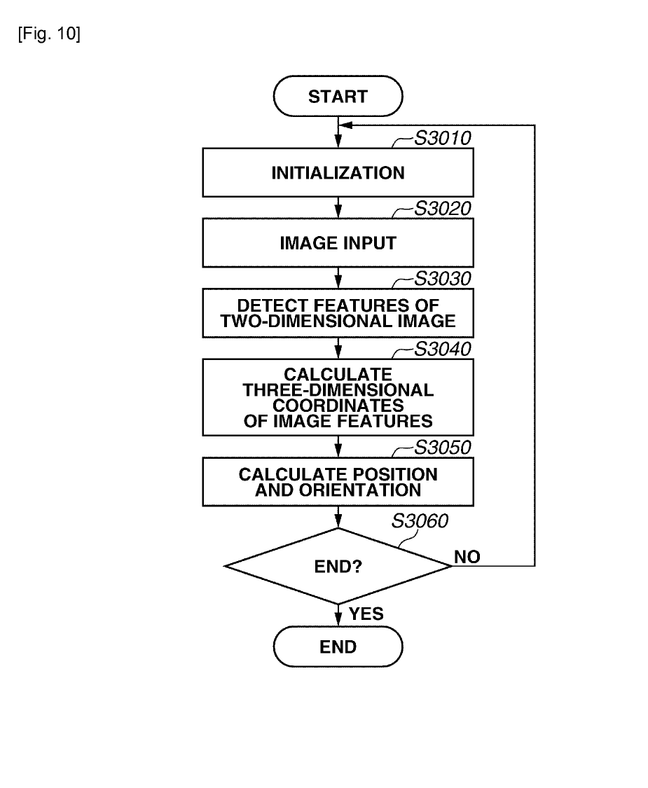

FIG. 10 is a flowchart illustrating an example of the processing for the position and orientation estimation (information processing method) of the information processing apparatus 300 according to the third exemplary embodiment of the present invention.

In step S3010, the information processing apparatus 300 initially performs initialization. A general position and orientation of the object are input by the same processing as step S1010 according to the first exemplary embodiment. Detailed description thereof will thus be omitted.

In step S3020, the two-dimensional image input unit 320 and the range image input unit 330 acquire measurement data for calculating the position and orientation of an object by model fitting. The two-dimensional image and the range image are input by the same processing as step S1020 according to the first exemplary embodiment. Detailed description thereof will thus be omitted.

In step S3030, the image feature detection unit 350 detects image features from the gray-scale image input in step S3020. As mentioned above, in the present exemplary embodiment, the image feature detection unit 350 detects edge features as the image features to be detected. For example, the image feature detection unit 350 may detect edges by using an edge detection filter such as a Sobel filter or by using the Canny algorithm. Any technique may be selected as long as the technique can detect regions where the image varies discontinuously in pixel value. In the present exemplary embodiment, the Canny algorithm is used for edge detection. Edges may be detected from the entire area of an image. Alternatively, the edge detection processing may be limited to part of an image. The area setting is not particularly limited and any method may be used as long as features of an object to be observed can be acquired from the image. In the present exemplary embodiment, the entire area of an image is subjected to edge detection. The Canny algorithm-based edge detection on the gray-scale image produces a binary image which includes edge regions and non-edge regions. After completing the detection of edge regions from the entire image, the image feature detection unit 350 ends the processing of step S3030. The processing proceeds to step S3040.

In step S3040, the image feature three-dimensional information calculation unit 360 calculates the three-dimensional coordinates of the edges that are detected from the gray-scale image in step S3030. The image feature three-dimensional information calculation unit 360 may calculate the three-dimensional coordinates of all the pixels in the edge regions detected in step S3030. Alternatively, the image feature three-dimensional information calculation unit 360 may sample pixels in the edge regions at equal intervals on the image before processing. A method for determining pixels on the edge regions is not limited as long as the processing cost is within a reasonable range.

In the present exemplary embodiment, the image feature three-dimensional information calculation unit 360 performs the processing of calculating three-dimensional coordinates on all the pixels in the edge regions detected in step S3030. The processing of calculating the three-dimensional coordinates of edges is generally the same as the processing of step S1040 according to the first exemplary embodiment. Detailed description thereof will thus be omitted. A difference from the first exemplary embodiment lies in that the processing that has been performed on each of the corresponding point candidates of edgelets in the first exemplary embodiment is applied to all the pixels in the edge regions detected in step S3030 in the present exemplary embodiment. After completing the processing of calculating the three-dimensional coordinates of all the edge region pixels in the gray-scale image, the image feature three-dimensional information calculation unit 360 ends the processing of step S3040. The processing proceeds to step S3050.

In step S3050, the position and orientation calculation unit 370 calculates the position and orientation of the object to be observed by correcting the general position and orientation of the object to be observed so that the three-dimensional shape model 30 fits into the measurement data in a three-dimensional space. In carrying out the correction, the position and orientation calculation unit 370 performs iterative operations using nonlinear optimization calculation.

Initially, the position and orientation calculation unit 370 associates the three-dimensional coordinates of the edge pixels calculated in step S3040 with three-dimensional lines of the three-dimensional model 10. The position and orientation calculation unit 370 calculates distances between the three-dimensional lines of the three-dimensional model which is converted into the camera coordinate system based on the general position and orientation of the object to be measured input in step S3010, and the three-dimensional coordinates of the edge pixels calculated in step S3040. The position and orientation calculation unit 370 thereby associates the three-dimensional coordinates of the edge pixels and the three-dimensional lines of the three-dimensional model 10 into pairs that minimize the distances. The position and orientation calculation unit 370 then optimizes the position and orientation based on the distances between the associated pairs of the three-dimensional coordinates of the edge pixels and the three-dimensional lines of the three-dimensional model.

The processing of optimizing the position and orientation is generally the same as the processing of step S1050 according to the first exemplary embodiment. Detailed description thereof will thus be omitted. The position and orientation calculation unit 370 repeats the processing of estimating the position and orientation to calculate the final position and orientation, and ends the processing of step S3050. The processing proceeds to step S3060.

In step S3060, the information processing apparatus 300 determines whether there is an input to end the calculation of the position and orientation. If it is determined that there is an input to end the calculation of the position and orientation (YES in step S3060), the information processing apparatus 300 ends the processing of the flowchart. On the other hand, if there is no user input to end the calculation of the position and orientation (NO in step S3060), the information processing apparatus 300 returns to step S3010 to acquire new images and calculate the position and orientation again.

According to the present exemplary embodiment, the information processing apparatus 300 detects edges from a gray-scale image, and calculates the three-dimensional coordinates of the detected edges from a range image. Thus, stable position and orientation estimation can be performed with high accuracy in the depth direction, which is unsusceptible to noise in the range image. Since edges that are undetectable from a range image can be detected from a gray-scale image, it is possible to estimate a position and orientation with high accuracy by using a greater amount of information.

A modification of the fourth exemplary embodiment deals with position and orientation estimation that is based on matching instead of least squares. In the first and third exemplary embodiments, the processing of estimating a position and orientation is performed based on the three-dimensional coordinates of features detected from a gray-scale image and a range image, and the three-dimensional lines of a three-dimensional model. More specifically, a position and orientation are estimated by calculating the amounts of correction in position and orientation that reduce differences in position between the three-dimensional coordinates and the three-dimensional lines in a three-dimensional space. However, the method of estimating a position and orientation is not limited to the foregoing. For example, a position and orientation that minimize differences in position between the three-dimensional coordinates of features calculated from a gray-scale image and a range image, and the three-dimensional lines of a three-dimensional model in a three-dimensional space may be determined by scanning a certain range without calculating the amounts of correction in position and orientation. The method of calculating a position and orientation is not particularly limited and any method may be used as long as the method can calculate a position and orientation such that the three-dimensional coordinates of features calculated from a gray-scale image and a range image fit into the three-dimensional lines of a three-dimensional model.

As an example of a useful applications, the information processing apparatus 100 according to an exemplary embodiment of the present invention can be installed on the end section of an industrial robot arm, in which case the information processing apparatus 100 is used to measure the position and orientation of an object to be gripped.

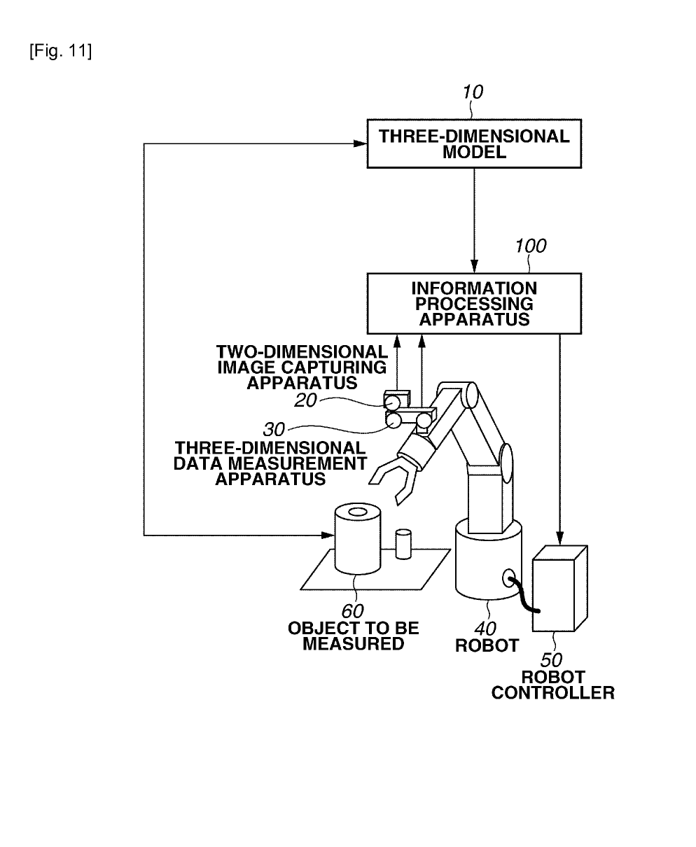

Referring to FIG. 11, an example of an application of the information processing apparatus 100, which is a fourth exemplary embodiment of the present invention, will be described below. FIG. 11 illustrates a configuration example of a robot system that grips an object 60 to be measured by using the information processing apparatus 100 and a robot 40. The robot 40 can move its arm end to a specified position and grip an object under control of a robot controller 50. The object 60 to be measured is placed in different positions on a workbench. Therefore, a general gripping position needs to be corrected to the current position of the object 60 to be measured. A two-dimensional image capturing apparatus 20 and a three-dimensional data measurement apparatus 30 are connected to the information processing apparatus 100. Data of a three-dimensional mode 10 conforms to the shape of the object 60 to be measured and is connected to the information processing apparatus 100.

The two-dimensional image capturing apparatus 20 and the three-dimensional data measurement apparatus 30 capture a two-dimensional image and a range image, respectively, in which the object 60 to be measured is imaged. The information processing apparatus 100 estimates the position and orientation of the object 60 to be measured with respect to the image capturing apparatuses 20 and 30 so that the three-dimensional shape model 10 fits into the two-dimensional image and the range image. The robot controller 50 controls the robot 40 based on the position and orientation of the object 60 to be measured that are output by the information processing apparatus 100. The robot controller 50 thereby moves the arm end of the robot 40 into a position and orientation where the arm end can grip the object 60 to be measured.

With the information processing apparatus 100 according to an exemplary embodiment of the present invention, the robot system can perform position and orientation estimation and grip the object 60 to be measured even if the position of the object 60 to be measured is not fixed.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-259420 filed Nov. 19, 2010, which is hereby incorporated by reference herein in its entirety.

1. An information processing apparatus comprising:
a three-dimensional model storage unit configured to store data of a three-dimensional model that describes a geometric feature of an object;
a two-dimensional image input unit configured to input a two-dimensional image in which the object is imaged;
a range image input unit configured to input a range image in which the object is imaged;
an image feature detection unit configured to detect an image feature from the two-dimensional image input from the two-dimensional image input unit;
an image feature three-dimensional information calculation unit configured to calculate three-dimensional coordinates corresponding to the image feature from the range image input from the range image input unit; and
a model fitting unit configured to fit the three-dimensional model into the three-dimensional coordinates of the image feature,
wherein an optical axis of a measurement apparatus of the two-dimensional image coincides with an optical axis of a measurement apparatus of the range image.

2. The information processing apparatus according to claim 1, wherein the model fitting unit collates the three-dimensional model based on a degree of matching or a degree of mismatching between the three-dimensional coordinates of the image feature and the three-dimensional model.

3. The information processing apparatus according to claim 2, wherein the model fitting unit calculates a position and orientation of the object based on a difference between the three-dimensional coordinates of the image feature and the three-dimensional model.

4. The information processing apparatus according to claim 1, wherein the two-dimensional image and the range image are captured from approximately identical viewpoints, and correspondence between the images is known.

5. The information processing apparatus according to claim 1, wherein the image feature three-dimensional information calculation unit calculates at least one or more sets of three-dimensional coordinates of the image feature by referring to the range image for a distance value corresponding to a vicinity of a position where the image feature is detected.

6. The information processing apparatus according to claim 5, wherein the image feature three-dimensional information calculation unit calculates the three-dimensional coordinates of the image feature based on an amount of statistics of a distance value calculated by referring to the range image for one or more distance values corresponding to the vicinity of the position where the image feature is detected.

7. The information processing apparatus according to claim 1, wherein the image feature detection unit detects an edge, a point, or a plane region as the image feature to be detected from the two-dimensional image.

8. The information processing apparatus according to claim 1, further comprising a position and orientation operation unit configured to change a position and orientation of an object to be measured or a measurement apparatus by using a robot having a movable axis based on a calculated position and orientation of the object to be measured, the movable axis being an axis of rotation and/or an axis of parallel movement.

9. An information processing method comprising:
storing data of a three-dimensional model that describes a geometric feature of an object;
inputting a two-dimensional image in which the object is imaged;
inputting a range image in which the object is imaged;
detecting an image feature from the input two-dimensional image;
calculating three-dimensional coordinates corresponding to the image feature from the input range image; and
collating the three-dimensional coordinates of e image feature with the three-dimensional model,
wherein an optical axis of a measurement apparatus of the two-dimensional image coincides with an optical axis of a measurement apparatus of the range image,

10. An information processing method comprising:
storing data of a three-dimensional model that describes a geometric feature of an object;
inputting a two-dimensional image in which the object is imaged;
inputting a range image in which the object is imaged;
detecting an image feature from the input two-dimensional image;
calculating three-dimensional coordinates corresponding to the image feature from the input range image; and
calculating a position and orientation of the object so that the three-dimensional model fits into a three-dimensional space,
wherein an optical axis of a measurement apparatus of the two-dimensional image coincides with an optical axis of a measurement apparatus of the range image.
